(19) United States
(12) Patent Application Publication
(10) Pub. No.: US 2011/0129752 A1
(43) Pub. Date: Jun. 2, 2011

(54) CONNECTION OF CHEMICAL OR THERMAL REACTORS

(76) Inventor: Dirk Peter Claassen, Graz (AT)

(21) Appl. No.: 12/598,751

(22) PCT Filed: Jun. 23, 2008
(86) PCT No.: PCT/AT2008/000226

§ 371 Date: Mar. 1, 2010

(30) Foreign Application Priority Data
May 4, 2007 (AT) A 649/2007

(51) Int. Cl. H01M 8/04; B01J 19/00; B01J 8/00; C03C 3/00; C03C 3/078

(52) U.S. Cl. 429/434; 422/198; 422/600; 501/11; 501/72

(57) ABSTRACT

The invention relates to the connection of one or more thermal and/or chemical reactors, particularly fuel cells, to an adjacent component or between two reactors or between two components, the reactors having a preferred operating temperature range, particularly between 400 and 1100° C., characterized in that said connection is provided by a connecting element that hardens at room temperature (normal state, normal conditions) and becomes plastic at the operating temperature.

### DESCRIPTION OF THE INVENTION

### Introduction

The invention relates to providing a connection between component parts of one or several chemical or thermal reactors, in particular tubular fuel cells manufactured from Cermet or metal or ceramics or a mixture of Cermet, metal or ceramics and their fastening points in a metallic or ceramic plate.

Specifically, a gastight connection for high-temperature fuel cells is to be provided with the aid of a solder, which is constituted such that, on the one hand, it hardens at room temperature and, on the other hand, becomes viscous and plastic in the operating range of the fuel cell (of the chemical or thermal reactor), preferably in a range from 400° C. to 1000° C., in order to equalize or counteract the thermal tensions which occur when the cell is brought up to the operating temperature or the cell is brought down from the operating to the ambient temperature as well as in the alternating-load operation as well as tensions which occur during the operation as a result of an external mechanical influence, thereby remains gastight and is attached between at least two component parts which have to be able to move relative to each other and to components of the chemical or thermal reactors which include such a sealing.

### BACKGROUND OF THE INVENTION

### Prior Art

Technical problems which occur when different materials are used in chemical or thermal reactors are associated especially with high operating temperatures and the thermal tensions of individual assembly elements of such reactor arrangements, in particular high-temperature fuel cells (in short, referred to as SOFC), which are caused by varying operating conditions, and the chemical resistance of the materials against each other as well as against the oxidants and reductants used.

For this reason, the research of new materials which combine different decisive features is intensified.

The general requirements for materials in the high-temperature range are:
chemical and physical long-term stability up to a temperature of about 1000° C. without degrading or reacting with the various component parts
stable in oxidizing and reducing atmospheres and under water vapour
capable of being thermally cycled, thermal reversibility

Furthermore, the following applies to materials used as sealing and connecting elements for component parts:
good adhesiveness to the components to be connected
elastic and resilient under operating conditions
pressure-proof and gastight
expansion coefficient adapted to the materials to be connected and flexible already at “temperatures which are as low as possible”

For thermal or chemical reactors such as, e.g., the fuel cells, it is important that the oxidants and reductants which are supplied to the separate sectional chambers and ionize with the appropriately charged electrodes of the chambers via electron exchange are physically sealed against diffusion (reaction gases and ions). Moreover, leakage through which one of the two reactants can escape from the reactors and get into contact with the environment or the other reactant must not occur in such reactors so that no undesired and uncontrolled reactions can take place.

Meanwhile, it has become common to connect reactors in the high-temperature range such as, e.g., the fuel cells in the joining areas with solders of various compositions, since solders, especially solder glasses, meet all the above-mentioned requirements best and can be adapted to the respective operating conditions with regard to their compositions.

In this area of application, BAS-glass (barium aluminium silicate glass) has turned out to be a basically suitable basic component for solder-glass mixtures. Thereby, the crystal phases and their proportion in the solder glass as well as the porosity resulting therefrom represent crucial criteria for the gastightness of the joining agent for the connection.

A list of different solders based on BAS-glass can be found in WO02/094727. Combinations with different additives for improving the rate of nuclei formation or increasing the glass-transition temperature and decreasing the surface tension for better wetting are provided therein as joining agents which all have a coefficient of thermal expansion of more than 11×10⁻⁶K⁻¹.

EP1010675 describes various further possible variants of soldering glasses for the connection of component parts in high-temperature fuel cells such as alkali oxide silicate glasses, mica glass-ceramics, alkaline earth oxide boron silicate/silica borate glasses or alkaline earth aluminium oxide silicates. Their respective advantages and disadvantages for particular applications are listed therein in short form, and even a compound solder glass based on Al₂O₃ and SiO₂ with one or several components from the group of metal oxides, which is interspersed with a filler, is claimed there.

These solder glasses and also those known from other patents are almost exclusively oxide powders which, in most cases, are mixed with an organic binder so that they can be applied as a solder material specifically to the parts to be connected.

Films which have already been sintered or molten and are produced from oxide powder mixed with a binder are also available on the market. The powder is thereby solidified in a sintering process and freed from the binder almost entirely. The films resulting therefrom are available under the name “solder glass green film” and permit easier assembly especially for fuel cells having planar structures.

New developments on the sector of chemical and thermal reactors, especially of tubular high-temperature fuel cells, move more and more toward a miniaturization of the components which can be designed with a diameter of a few millimetres up to a diameter of a few 100 micrometres (see final report of the project group “renewable energies” of the technical insurers in the GDV, status of March 2005).

The following advantages result from this development:
faster start-up time of the reactors
easier manufacture in comparison to large electrodes and, as a result, less expensive industrial mass production
thermal shock resistance
high mechanical integrity
substantial miniaturization
drastic increase in power density by an improved ratio of reactive surface to media passing through

However, problems with chemical or thermal reactors may always occur in connection with high temperatures when large temperature gradients occur within the units. If the units, which preferably have a tubular design, are fixed on both sides in a mounting and the expansion coefficient or the expansion behaviour of the mounting differs, e.g., under a one-sided intense heating, just slightly from the behaviour of the tubular unit, this may result in damage to—and even in a break of—the tubular unit and, hence, ultimately in a loss of the function of the reactor.

In order to illustrate the magnitude of a deformation in the radial direction, an example which was generated by means of a simulation calculation is given below.

The expansion behaviour in the axial direction, which is to be treated equally, is not addressed further in this example.

We look at a tubular unit made of Cermet, ceramics or metal; in particular made of coated NiO/YSZ Cermet, which is firmly clamped on one side and is supplied with a temperature gradient of more than 10 K for the “top” and “bottom sides” at an operating temperature of about 1100 K. The respective thermal load is illustrated in the enclosure in FIG. 1.

If the dimension of the tube is assumed to have a length of 60 mm and the diameter is assumed to be 3 mm, a deflection of a magnitude of about 0.1 mm results from the simulation calculation. The greatly enlarged illustration of the deflection is shown in the enclosure in FIG. 2.

From this example, it is obvious that minor temperature differences, which are produced here by a gradient of merely 27 K, can already have effects on the stability and integrity of the connection and thus also of the reactors. If the temperature difference becomes even larger and the tubular unit is fixed too strongly to the juncture by the connecting element, capillary cracks for relieving tensions may occur in the reactor, but a break across the entire cross-section of the chemical or thermal reactor is also possible.

In order to be able to avoid these effects, which are extremely undesirable for the service lives of the reactors, the reactors must be mounted so as to be freely movable at least in one of the two anchoring points, despite the complete gastightness and stability of the connection.

### OBJECT OF THE INVENTION

It is the object of the invention to provide a new method and a new connecting material such as a connection which can be implemented between a mounting and/or a casing made of metal or ceramics and a chemical or thermal reactor made of coated Cermet, metal or ceramics, or one or several reactors made of coated Cermet, metal or ceramics among each other, in particular of high-temperature fuel cells, which remains stable and gastight in the temperature range which is the basis for the application of the reactors in a thermal alternating-load operation and, in doing so, still relieves or counterbalances the tensions in and between the component parts which occur as a result of the slightly different expansion coefficients of the materials to be connected and their thermal load conditions as well as tensions and relative motions caused by external mechanical influences on and between the component parts.

Specifically, a commercially available crown glass is thereby used as a joining material in order to reduce the costs of manufacturing the connection. It has the properties which are important for the integrity of the reactors, namely that it sticks to the materials to be connected and is gastight in the temperature range of interest between 800 K and 1300 K and thereby exhibits the essential feature of an appropriate viscosity in order to equalize the thermal tensions between the component parts of chemical or thermal reactors and the mountings or casings as well as between the reactors themselves.

### DESCRIPTION OF THE INVENTION

### Short Description of the Drawings

FIG. 1: static temperature distribution in a Cermet tube made of NiO/YSZ

FIG. 2: deformation of a NiO/YSZ Cermet tube at a temperature gradient of 27° and an operating temperature of 1100° K, which is shown in a greatly enlarged illustration

FIG. 3: comparison of the expansion coefficients of typical materials for high-temperature fuel cells to the claimed solder glass

FIG. 4: schematic illustration of the connection without a support ring

FIG. 5: schematic illustration of the connection with a support ring lying at the top

FIG. 6: schematic illustration of the connection with a support ring lying at the bottom

FIG. 7: schematic illustration of the connection with a support ring on both sides

FIG. 8: schematic illustration of the connection with a crowned mounting and a crowned support ring lying at the top

FIG. 9: schematic illustration of the connection for an upward-tapered tubular reactor without a support ring

FIG. 10: schematic illustration of the connection for a tubular reactor reinforced upwards without a support ring

FIG. 11: schematic illustration of the connection in a reactor assembly with an alternately arranged support ring

FIG. 12: schematic illustration of the connection in a reactor assembly with a crowned mounting and alternately arranged crowned support rings

FIG. 13: schematic illustration of the connection in a reactor assembly with a crowned mounting and tubular reactors alternately incorporated in hollows and elevations

### DETAILED DESCRIPTION OF THE DRAWING

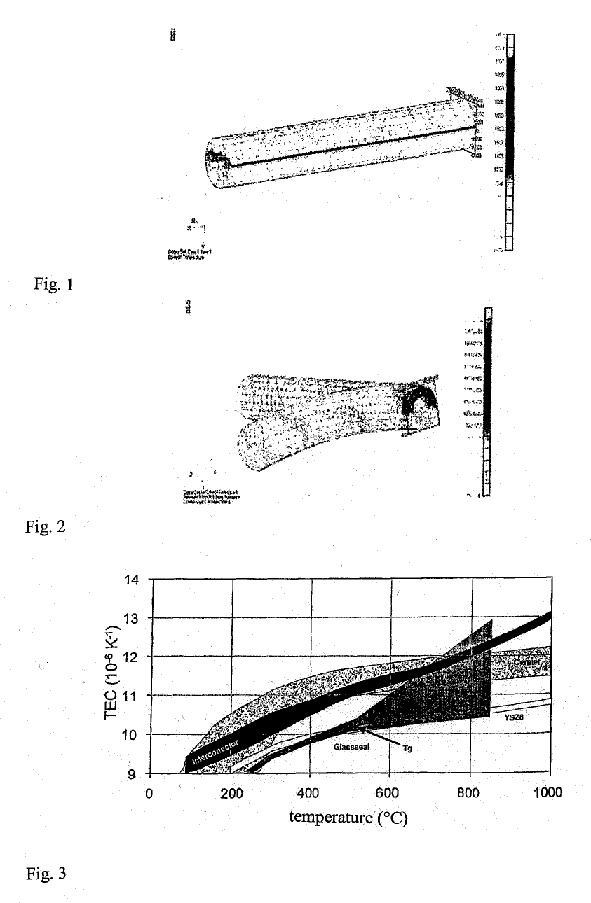

Explanations with regard to FIGS. 1 and 2 have already been made in the general description part.

FIG. 3 shows the range of the expansion coefficients of materials as they are typically used in the field of SOFCs. They move in the temperature ranges of interest between 10^{-5°}K⁻¹ and 1.2×10⁻⁵K⁻¹. As can be seen from the illustration, the expansion coefficient of the claimed solder is in a range which is favourable for the other materials. The illustration also shows that the thermal expansion of the solder changes drastically after the transformation point T_{g}, is no longer clearly ascertainable and widens. This property is basically desirable, since a larger operating range can thereby be covered with the solder.

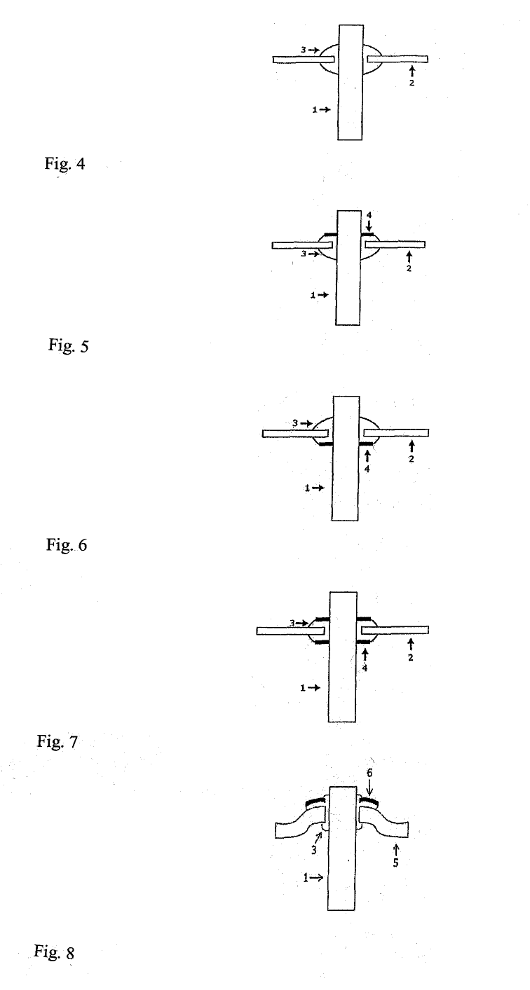

Now, the invention is to be explained on the basis of FIGS. 4 to 13, without thereby restricting the scope of the claims to the tubular application or in any other form. An application of the invention in the field of planar structures and planar chemical or thermal reactors is likewise possible along the lines of the following descriptions.

As has already been mentioned in the text, the contact area consists of a perforated mounting (2), which, in the following, is referred to as a cover sheet or a perforated sheet, and, preferably, is made of Crofer 22 APU. These mountings serve for “fixing” the chemical or thermal reactors (1), which, in a preferred embodiment, consist of Cermet, specifically of an NiO/YSZ Cermet coated with a thin layer of YSZ. If these reactors have a tubular design, an annular expansion joint remains between the tubular unit and the mounting, which is necessary for being able to equalize different thermal tensions resulting from slightly different expansion coefficients in the individual materials, as well as mechanical relative motions. In order that the functionality of the reactors is ensured, said expansion joint has to be closed in a gastight manner by means of a connecting element (3), specifically by a solder glass.

The simplest embodiment is illustrated in FIG. 4. Therein, the connecting element can be applied, for example, annularly or as a paste and a gastight bond can be generated with the parts to be connected by a defined heating cycle, wherein the connecting element covers the expansion joint to be closed or penetrates it and firmly sticks to the parts to be connected (of the mounting and the reactor). The connection thus obtained is gas impermeable as well as heat-, oxidation- and reduction-resistant.

If the connection is to be reinforced additionally, an additional component part (4) for reducing the clearance can be applied.

To be able to describe the illustrations more easily, this additional component part is referred to in the following as a support ring, but may also be designed differently. In a preferred embodiment, said component part is made of Crofer 22 APU. The function of the support ring can be seen in the enclosure in FIG. 5.

Said support ring itself, which is used optionally, possesses two essential functions for the connection.

On the one hand, the support ring (the additional component part) is drawn during operation toward the mounting by the surface tension of the connecting element, thereby reducing the gap to be closed.

On the other hand, the support ring also completely covers the expansion joint which is enlarged on one side during a lateral movement of the chemical or thermal reactor. As a result, the connecting element remains in the expansion joint more stably since it is additionally prevented from flowing out by the support ring.

By designing the connection with a support ring as described above, the reactor remains flexible in the expansion joint in the desired range and, at the same time, the connection remains tight. For this reason, damage to and ultimately even a break of the reactor can be avoided. If one looks at the connection thus obtained, a high-temperature bearing of the reactor may be mentioned in this context.

Further advantageous embodiments of the connection are illustrated in FIGS. 6 and 7 as well as 11. Therein, the additional support ring (4) may also be arranged underneath the mounting (2), on both sides, or in a reactor assembly alternately above and below the mounting.

In FIGS. 8, 12 and 13 of embodiments, variants are shown in which the mounting (5) is crowned at the positions where chemical or thermal reactors are used. In principle, the crowning may be implemented in both directions, but is illustrated here in FIGS. 8 and 12 only toward one side for demonstrating the connection. As before, either only one connecting element alone can again be used, or, according to the previous embodiments, one or two support rings can in addition be used in the different variants, which have already been described. The support ring (6), which is used here, has the same crowning like the juncture. This form is of interest because lateral movements occur in the form of a curvature of the tubular units around a centre of curvature, which lateral movements are caused by a one-sided thermal load on tubular reactors. If the mounting (5) and the support ring (6) are adapted in their geometries to the curvature of the tubular reactors, the distance of the support ring from the mounting remains unchanged during a lateral shift, and hence also the expansion gap to be closed.

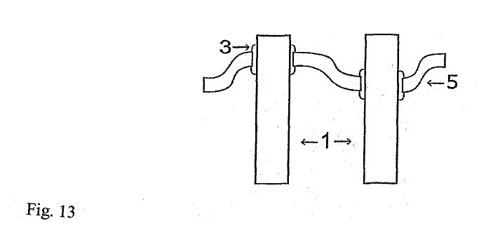

The design differences in FIGS. 12 and 13 result from the different arrangements of the tubular reactors. In FIG. 12, the tubular units are always inserted into the same spot of the mounting, i.e., either into the recesses or into the elevations, in FIG. 13, the tubular units are inserted alternately into the recesses and elevations. As before, the connection itself can again be effected with only one connecting element, but all other variants with one or two support rings, as already explained previously, are also possible.

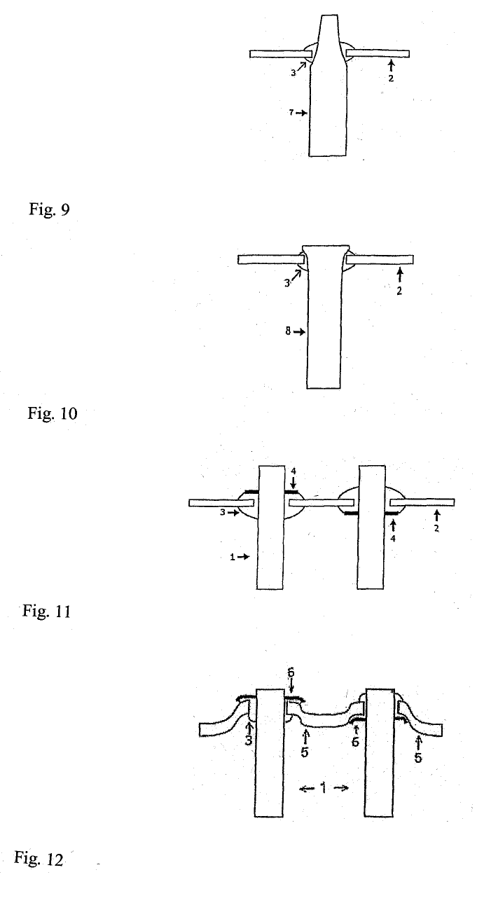

The characteristic feature in FIGS. 9 and 10 is provided by the design of the tubular reactors. It is characterized firstly by a taper (7) at the juncture and secondly by a broadening (8). Both variants are designed such that, in principle, they can assume the function of the support ring and make sure that the connecting element stays better in the joint gap. In both cases, an additional support ring can optionally be arranged on the opposite side of the mounting in order to reinforce the connection. In principle, the broadening can also be implemented by an end cap placed on the tubular unit.

Description of the Solder-Glass Mixture—Summary

The solder, as mentioned in claim 6, consists of the basic components SiO₂, Na₂O, K₂O, CaO, ZnO and BaO with additions of TiO₂ as a nucleating agent and Sb₂O₃ as a fluxing agent. Additions of Al₂O₃, ZrO₂, B₂O₃, BO₂, MgO and/or LiO₂ for improving the long-term stability of the solder are likewise conceivable or desired.

The composition of this solder is suitable as a connecting element for chemical or thermal reactors, specifically of high-temperature fuel cells, especially because it is a so-called “long” glass. This means that the lower expansion limit, the upper cooling point, the softening point and the processing point of the glass are “far” apart on the temperature scale.

The transformation point T_{g}, which separates the brittle energy-elastic range from the soft entropy-elastic range, is below 550° C. and thus in a range which is highly favourable for the connection. Thermal tensions and deformations caused by a one-sided thermal impact, as they normally occur during operation when the fuel cells are started up or also when they are shut down, can be absorbed in this manner much more easily and already from a lower temperature range as it is the case with solder glasses which are currently common.

A further advantage of this composition is that it can be heated to about 1300 K without any components substantially evaporating therefrom, which contaminate the reactors (cells) and thereby reduce the performance, and, as a result of the evaporation of components, might, in addition, render the connection unstable.

Changes in the composition of the weight percentage of the individual components of the solder glass relative to each other permit specific adaptations of the specifications of the solder glass to the properties of the materials to be connected, such as, e.g., the surface tension or the expansion coefficient.

A solder-glass mixture based on a commercially available colourless highly transparent crown glass (modified soda-lime glass) is regarded as particularly suitable for the connection of microtubular Cermet units to a metal mounting, which is preferably manufactured from Crofer 22 APU.

Advantageous methods of applying the solder glass to the parts to be connected consist in manufacturing rings of appropriate sizes or grinding the glass to a fine-grained powder and mixing the powder with a liquid or a suitable binder in order to produce a paste therefrom. Said paste can be applied directly to the parts to be joined, and the connection can be rendered gastight by baking the liquid or the binder.

1.-8. (canceled)

9. A connection of one or several thermal and/or chemical reactors to an adjacent component part or between two reactors or between two component parts, with the reactors or component parts having an operating temperature range between 400° C. and 1100° C., characterized in that said connection is established via a connecting element consisting of a solder glass, which, under normal conditions, hardens at room temperature and becomes plastic at operating temperature.

10. A connection according to claim 9, characterized in that the reactor includes a microtubular high-temperature fuel cell.

11. A connection according to claim 9, characterized in that the connecting element is a crown glass.

12. A connection according to claim 9, characterized in that, in addition to main component SiO₂ and to at least two of three main components from the group of CaO, BaO or Sb₂O₃, the solder glass contains at least one of the remaining components indicated in the following table in percent by weight:

| chemical name | % by weight |
|---|---|
| SiO₂ | >39 |
| Na₂O | 0-10 |
| K₂O | 0-15 |
| CaO | 0-10 |
| BaO | 0-10 |
| ZnO | 0-20 |
| TiO₂ | 0-6 |
| Sb₂O₃ | 0-1 |
| Al₂O₃ | 0-20 |
| LiO₂ | 0-6 |
| B₂O₃ | 0-20 |
| MgO | 0-10 |
| BO₂ | 0-14 |
| ZrO₂ | 0-10 |

13. A connection according to claim 9, characterized in that the solder glass used has the following chemical composition in percent by weight:

| chemical name | % by weight |
|---|---|
| SiO₂ | >50 |
| Na₂O | 1-10 |
| K₂O | 1-10 |
| CaO | 1-10 |
| BaO | 1-10 |
| ZnO | 1-10 |
| TiO₂ | 0.1-1 |
| Sb₂O₃ | 0.1-1 |

14. A connection according to claim 9, characterized in that the connecting element is configured to allow shifts of up to 1 mm.

15. A connection according to claim 9, characterized in that an additional component part is inserted for reducing clearance between the reactor(s) and/or component(s).

16. A connection according to claim 15, characterized in that the additional component part is annular.

17. A connection according to claim 10, characterized in that, in addition to the main component SiO₂ and to at least two of the three main components from the group of CaO, BaO or Sb₂O₃, the solder glass contains at least one of the remaining components indicated in the following table in percent by weight:

| chemical name | % by weight |
|---|---|
| SiO₂ | >39 |
| Na₂O | 0-10 |
| K₂O | 0-15 |
| CaO | 0-10 |
| BaO | 0-10 |
| ZnO | 0-20 |
| TiO₂ | 0-6 |
| Sb₂O₃ | 0-1 |
| Al₂O₃ | 0-20 |
| LiO₂ | 0-6 |
| B₂O₃ | 0-20 |
| MgO | 0-10 |
| BO₂ | 0-14 |
| ZrO₂ | 0-10 |

18. A connection according to claim 10, characterized in that the solder glass used has the following chemical composition in percent by weight:

| chemical name | % by weight |
|---|---|
| SiO₂ | >50 |
| Na₂O | 1-10 |
| K₂O | 1-10 |
| CaO | 1-10 |
| BaO | 1-10 |
| ZnO | 1-10 |
| TiO₂ | 0.1-1 |
| Sb₂O₃ | 0.1-1 |

19. A connection according to claim 12, characterized in that the connecting element is configured to allow shifts of up to 1 mm.

20. A connection according to claim 13, characterized in that the connecting element is configured to allow shifts of up to 1 mm.

21. A connection according to claim 12, characterized in that an additional component part is inserted for reducing clearance between the reactor(s) and/or component(s).

22. A connection according to claim 13, characterized in that an additional component part is inserted for reducing clearance between the reactor(s) and/or component(s).

23. A connection according to claim 14, characterized in that an additional component part is inserted for reducing clearance between the reactor(s) and/or component(s).

24. A connection according to claim 21, characterized in that the additional component part is annular.

25. A connection according to claim 22, characterized in that the additional component part is annular.

26. A connection according to claim 23, characterized in that the additional component part is annular.

27. A connection element comprising:
a connection member configured to couple two adjacent reactors and/or reactor components having an operating temperature range between 400° C. and 1100° C., said connection member consisting of solder glass configured to harden at room temperature and become plastic at operating temperature.

28. A connection according to claim 27, characterized in that the solder glass used has the following chemical composition in percent by weight:

| chemical name | % by weight |
|---|---|
| SiO₂ | >50 |
| Na₂O | 1-10 |
| K₂O | 1-10 |
| CaO | 1-10 |
| BaO | 1-10 |
| ZnO | 1-10 |
| TiO₂ | 0.1-1 |
| Sb₂O₃ | 0.1-1 |
